(19) United States
(12) Patent Application Publication
(10) Pub. No.: US 2008/0204225 A1
(43) Pub. Date: Aug. 28, 2008

(54) System for measuring and analyzing human movement

(76) Inventor: David Kitchen, Bowling Green, KY (US)

Correspondence Address: STOCKWELL & SMEDLEY, PSC, 861 CORPORATE DRIVE, SUITE 200, LEXINGTON, KY, 40503, US

(21) Appl. No.: 11/796,965

(22) Filed: Apr. 30, 2007

Related U.S. Application Data
(60) Provisional application No. 60/902,720, filed on Feb. 22, 2007.

(51) Int. Cl. H04Q 7/00

(52) U.S. Cl. 340/539.22

(57) ABSTRACT

A system for recording force and motion data obtained from a user during an exercise workout or other physical movement is disclosed. The system also can interact with a web-portal mechanism.

### CROSS-REFERENCE TO RELATED APPLICATIONS

This application claims priority to U.S. Provisional Application No. 60/902,720 which was filed on Feb. 22, 2007.

### FIELD OF THE INVENTION

The present invention relates to a system for obtaining a variety of types of data that occurs in human movement.

### BACKGROUND OF THE INVENTION

Everyone's personal physiology is different, and thus their reasons for lifting weights or needing physical therapy can also be different. For example, one weight lifter can have an entirely different goal from another. However, achieving weight lifting goals often requires adhering to a specific strict regimen which can differ significantly from one person to another. The same is true for physical therapy, and for workplace movements. Consequently, an improved mechanism for measuring human movement is desired.

### BRIEF DESCRIPTION OF THE DRAWINGS

FIGS. 1A and 1B show various features of the present invention;

FIGS. 2A and 2B shows additional detail of embodiment of FIG. 1;

FIGS. 3A and 3B show an overview of various portions of the present invention;

FIGS. 4-12 show exemplary software user panels for use within the present invention;

FIG. 13 shows an exemplary website for use within the present invention;

FIG. 14 shows an exemplary health club or gym environment incorporating various features of the present invention; and

FIGS. 15A-15D show how the present invention could assist in modifying a user's physical therapy routine.

### DETAILED DESCRIPTION OF THE PREFERRED EMBODIMENTS

Before explaining the disclosed embodiment of the present invention in detail it is to be understood that the invention is not limited in its application to the details of the particular arrangement shown, since the invention is capable of other embodiments. Also, the terminology used herein is for the purpose of description and not of limitation.

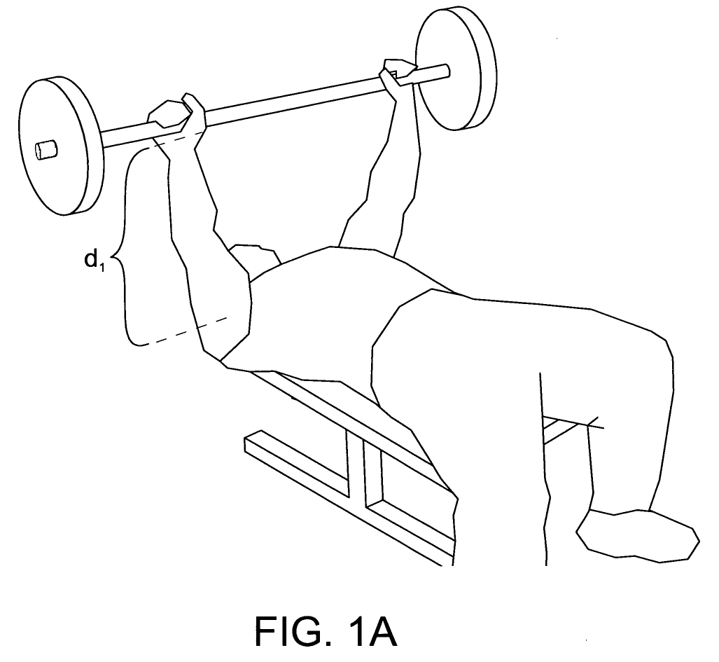

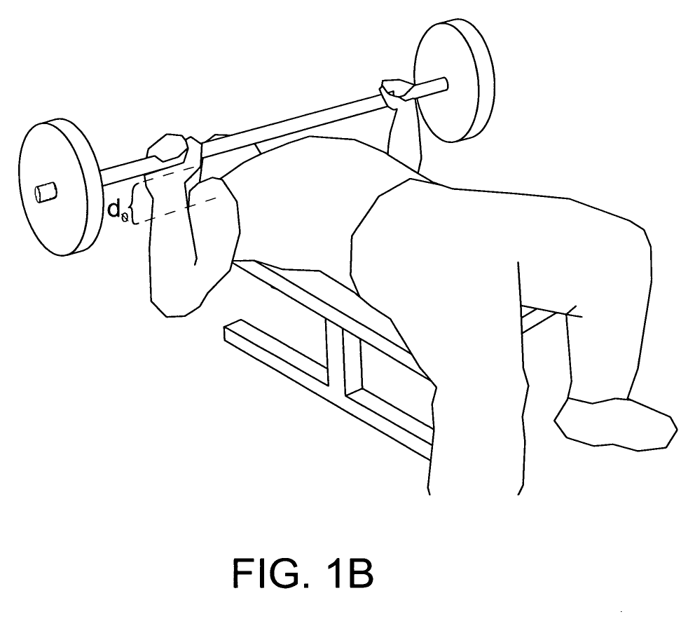

The present invention is directed toward an apparatus, method, and system for detecting specific types of human motion, such as but not limited to motion that occurs during a workout such as lifting weights. To illustrate the invention, the example of a weight lifter will be used in FIGS. 1A and 1B, although the present invention should not be considered as limited exclusively thereto.

To that end, FIG. 1A shows a weight lifter and potential user of the present invention. FIG. 1A further shows a distance d₁, which connotes the travel of a weight bar when the user's arms are fully-extended, and is the distance between the user's palms and the centerpoint of their shoulder. Meanwhile, FIG. 1B shows a distance do, which is the distance between the user's palms (applying the force to the weight bar) and the centerpoint of their shoulder when the user's arms are folded and not yet lifting.

The distance d_{w} (d₁−d₀) is the distance that work as actually performed by the weight lifter within FIG. 1. It is well-known that work==force×distance. Within the United States, weight-lifters and other participants in various types of exercise and medicine measure weights mostly in pounds. To that end, this patent application will discuss the present invention in terms of the English, rather than the Metric, system of measurement. Thus, within the English system, force is measured in units of pounds, distance is measured in units of feet, so that work, as discussed above, is measured in units of foot-pounds.

Another important consideration in weight-lifting is power. Power is defined as the time rate of doing work, and is measured by dividing work by time elapsed to do that work, so that power==work/time. Power can be measured in horsepower, but also can be measured in kilowatts. In the context of weight lifting, power may somewhat indirectly related to strength, although this relationship is imperfect and is-somewhat of an oversimplification.

Lifting a specific amount of weight very quickly, with several repetitions, can lead to increased power, which can be, but not necessarily is, related to muscle mass. Meanwhile, lifting the same amount of weight with the same amount of repetitions, but at a much slower rate, may be useful for muscle tone but not as useful for muscle mass, and will certainly require less power be expended by the user. The amount of force a muscle generates is proportional to muscle growth. Thus, depending on the user's desired outcome, for example either muscle mass or muscle tone, both faster and slower techniques, respectively, can be beneficial. The present invention can assist a user in arriving at either of the above results, as well as a vast assortment of other outcomes.

Strength can be defined as the ability to produce force. Force is defined as mass multiplied by acceleration. Power production is the product of force and velocity and is likely the most important factor in determining success in most sports. The ability to generate force is an integral part of power production and therefore may be a key component in determining athletic success.

Slow weight training produces less tissue trauma at the start and finish of the exercise movement and is therefore less likely to produce training injuries. Fast weight training appears to be counterproductive with respect to maximum strength development because muscle force decreases as movement speed increases. Although heavier weight loads can be used, the target muscle group actually receives less training stimulus due to the momentum factor and stress on the joint structures are increased.

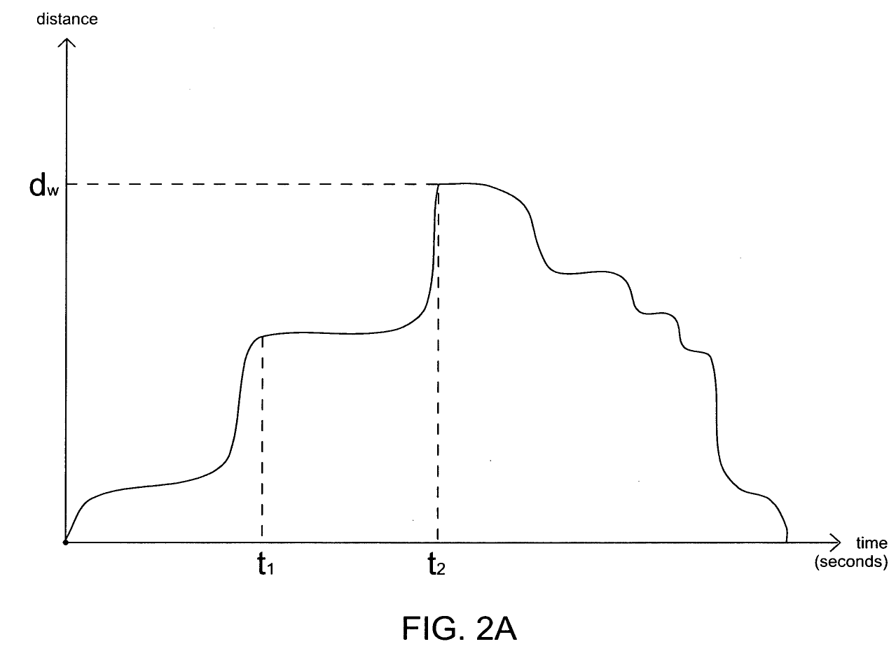

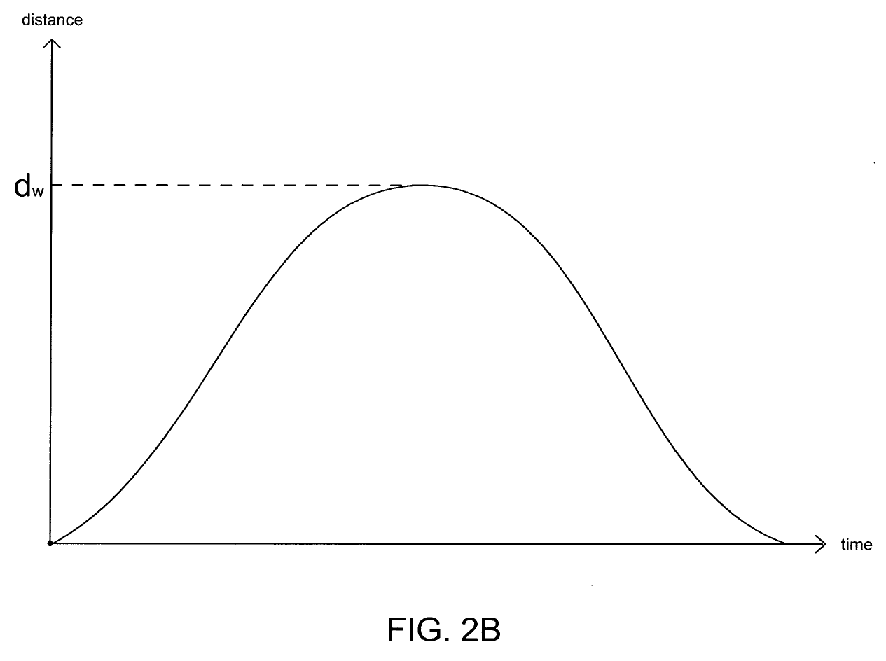

To clarify the power relationships of the present invention, FIG. 2A shows the vertical and horizontal coordinates of a graph representing the travel distance d_{w} of the weight bar over time. The vertical axis represents the travel distance d_{w} of the weight bar, of course subtracting the offset d₀, while the horizontal axis represents time. For clarity, FIG. 2A is intentionally oversimplified, in that it shows only a single lifting of a specific amount of weight. It is well known that lifters will lift various weights in various repetitions and schedules. Thus, it is an intended feature of the system 100 of the present invention to provide graphic representations of groups of repetitions of weights, and not merely a single repetition, as will be discussed in more detail elsewhere.

From FIG. 2A it is apparent that a user is not consistently applying force over the time-interval shown. Specifically, at times t₁ and t₂, the user's application of force to the weight bar “spikes”, so that the weight bar moves a large (proportionately) distance in an extremely short time. The effect of such sudden movement or jerking of the weights can be to develop muscle mass disproportionately, and also to not evenly distribute that muscle mass over a user's frame. Instead, bulges or pockets of muscle mass could develop unevenly, which could become unsightly over time and therefore undesired. Also, when a lifter jerks the weights and does not have a smooth movement, muscle cramping and pulling of muscles can occur, as well as soreness of the back and spine.

FIG. 2B shows another possible workout scenario. From FIG. 2B it is apparent that the user is evenly exerting the same amount of power throughout the entire repetition. This can be beneficial for the user. The system 100 of the present invention obtains this information for the user, without requiring any special modification of the user's workout routine.

Because the distance and the force of the weight is the same in FIGS. 2A and 2B, the actual work performed by the user is the same. However, the power exerted by the user is not the same. Thus, measuring effectiveness of a workout merely by actual work performed, as is commonly practiced, provides a somewhat incomplete analysis of the workout. The present invention provides a way of obtaining more detailed information about a workout, including but not limited to power expended, and also power distribution.

It is to be noted that the various outcomes desired from weight lifting are hugely more complex than just muscle mass and muscle tone. These conditions are discussed merely for exemplary purposes only, so that the present invention should not be considered as limited exclusively thereto. Other desired conditions exist, including but not limited to endurance, pure strength, physical therapy aspects including recovery from an injury, as well as avoidance of repetitive motion injuries and soreness. Numerous theories exist as to how to achieve these desired conditions. The present invention takes no position as to which of these theories has the greatest validity. Instead, the present invention measures, transmits, and records the important measurement data that is not available by other means, and then allows the user to make use of this data any way they see fit, according to any theory they want to use.

For example, various well-known lifting protocols can be accommodated by the system 100 of the present invention. These include but are not limited to High Intensity Training (HIT), Max OT (Maximum Overload Training), German Volume Training (GVT), as well as Hypertrophy Specific Training (HST). Other protocols are also contemplated within the spirit and scope of the present invention.

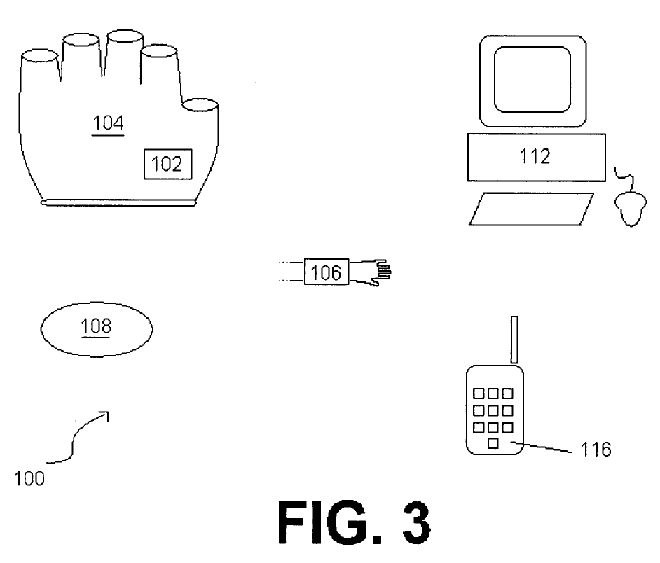

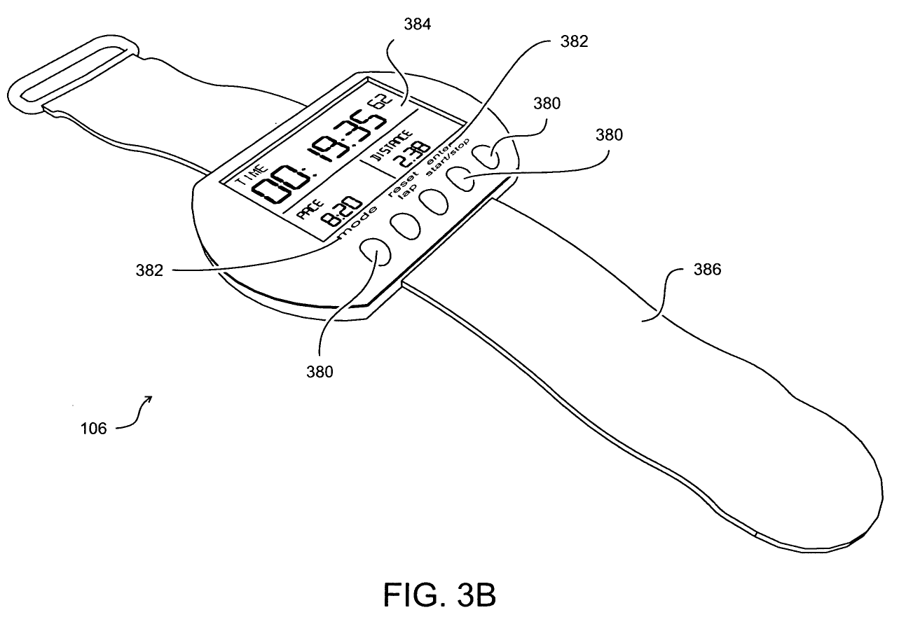

From FIG. 3 it is apparent that the system 100 comprises at least for example a glove 104 which has various sensors embedded therein, a microprocessor device 106, optionally a sensor 108 which attaches to the user's shoulder, useful for determining distance of movement, and a transmitter or plurality of transmitters 102 for forwarding the data. These devices can relay data not only to each other, but also to a nearby computer 112 or a cellphone 116, using communication means including but not limited to BlueTooth® and WiFi®. A cellphone 116 is specifically suggested within the system 100 because many people bring their cellphones to the gym, but very few bring their laptops, Palm, or Pocket PC devices.

However, regardless of what equipment a user has or brings, it is apparent from these examples that a user could use the system 100 either in their own home, or at a public gym. A heart monitor can also be incorporated into the system 100, as well as a thermometer, as well as a means for detecting pulse rate.

As suggested within FIG. 3, the system 100 of the present invention can measure distance, weight, work, power, and numerous other datapoints through various electronic means which are non-intrusive to the user, and do not interfere with the user's workout or occupational or physical therapy body movement. By doing so, the system 100 can thereby assist that user in maximizing an exercise routine, work-out, therapy, or job-related physical movement that is best for their individual physiology.

Applying the system 100 of FIG. 3A to FIGS. 1A and 1B, the user would be wearing the microprocessor device 106 on the wrist and/or the glove 104, and also potentially having the distance sensor 108 attached to the shoulder. After understanding the role of these two devices, it becomes easier to see how the distance d_{w} (d₁−d₀) is measured. It is important to note that for the system 100 to provide useful reliable data to a user or medical observer, the various devices incorporated therein must provide reliable data. Consequently, the sensor 108 can work in conjunction with the glove 104, the microprocessor device 106, and potentially the base computer 112 to strip out anomalous or aberrant data.

Additionally, a further embodiment of the system 100 exists in which the various distances and movements of a user can be measured by a single device, such as but not limited to the glove 104. One possible way to achieve this is through incorporating an accelerometer within one or more of the sensing devices within the system 100, such as but not limited to the glove 104 or the distance sensor 108. The glove 104 or other sensory device can also contain load cell sensors, heart rate monitor and a distance calculating device that are strategically located in gloves, leg straps or other mechanisms suitable for attachment to a human body.

The microprocessor 106 could have several features, such as but not limited to user-operable keypad, a display, a USB port, and a slot to accept a memory stick or card. The input to the microprocessor device 106 may be manual, but could also be an automated wireless link with the glove 104 or other sensing device as the user performs the workout and then the data is saved to the device.

As shown in FIG. 3A, the microprocessor device 106 could conceivably be worn by a user on a wrist or forearm. However, the microprocessor could also be strapped to the surface of a weight machine so that a user may read the display while working out, while staying in workout position without hindering movement.

An exemplary embodiment of the microprocessor device 106 is shown in FIG. 3B. The device 106 is worn like a wristwatch, where the display 384 is visible by the user. The application-specific indicator lights 382 can show status of various features. The user operates the device 106 via the various push-buttons 380.

As shown in FIG. 3A, the microprocessor device 106 is easily worn on the forearm, although other attachment means can be used. In the event a user does a workout but forgets to bring their microprocessor device 106, software 400 used within the system 100 allows a user to easily add the workout data.

The microprocessor device 106 is not intended to be the end-all storage device, as the present invention anticipates being incorporated with other devices as shown in FIGS. 3A-3B. Thus, the microprocessor 106 may be limited in what it can record, ie, the exercise, sets, weight and reps, with a time-stamp for each. However, the microprocessor 106 could also have other consumer-friendly features, such as monitoring heart rate, and even potentially the ability to play MP3s. Certain embodiments of the microprocessor 106 may have limited internal storage, where some data may be off-loaded to disk, USB stick, or other portable memory device. However, other embodiments may have vast storage capabilities which do not require off-loading of storage.

The microprocessor device 106 can also be used without the glove 104 as a basic workout log. Within such a non-sensory embodiment, all user input would be manual-only, using various buttons and arrows on a user-surface of the microprocessor 106.

An exemplary list of features used with the software of the system 100 of the present invention could include, but is not limited to, a one-rep-maximum (1RM), a body fat calculator, graphs, history, cardio, lifts, template, workout, calendar, and body measurement features. The graph feature will display historical workout data graphic form in order to make easy visual comparisons. The history feature provides a record of previous saved workouts. The cardio feature could track, for example, exercise, length, distance, intensity, heart rate, and calories burned. The workout feature identifies the specific exercises performed in a certain workout, where user-configurable notes can be attached to any workout performed. In this way, the microprocessor device 106 as well as other features of the present invention are user-configurable and user-customizeable.

After creating such a template, the user could select that template and then workout. As the workout is performed the weight, sets and reps are manually entered. If the template was created with a time between exercises, sets and reps then there is an audible beep when the time has elapsed once the data of the previous exercise, set or rep has been entered. Once complete the workout is saved and then becomes part of the history file. The calendar shows previous and planned future workouts by name on a monthly calendar. The workout can be viewed from this screen.

As stated, the microprocessor device 106 could be a stand alone unit, but could also be made available with PC-based software. This will enable the user to transfer information from the microprocessor device 106 to their PC and from the PC back to the microprocessor device 106. Thus, all information that was available on the microprocessor device 106 will also be available on the PC. All inputs available on the microprocessor device 106 can also be entered on the PC and then transferred to the microprocessor device 106, which may be more convenient for the user. The PC software will have additional charting and analysis features that are not present within the microprocessor device 106.

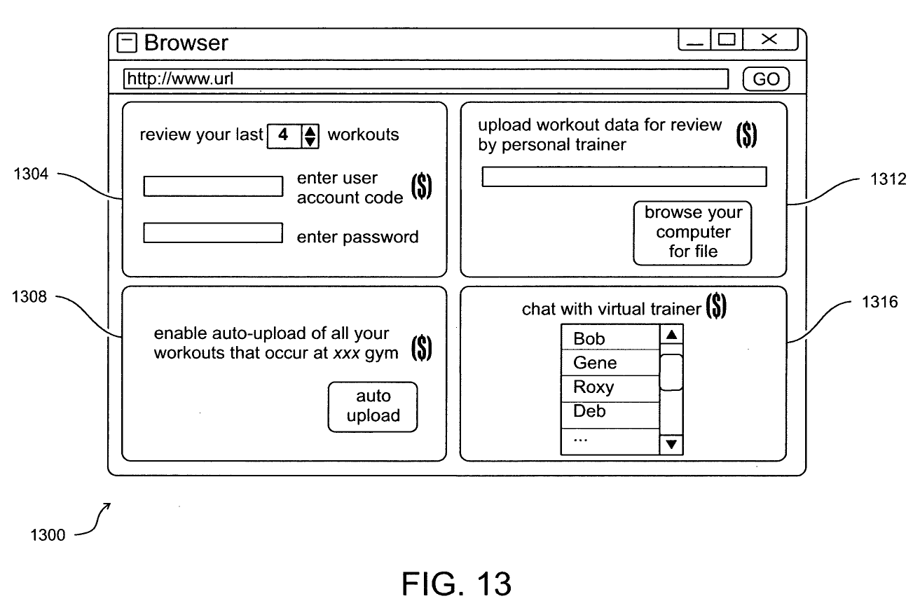

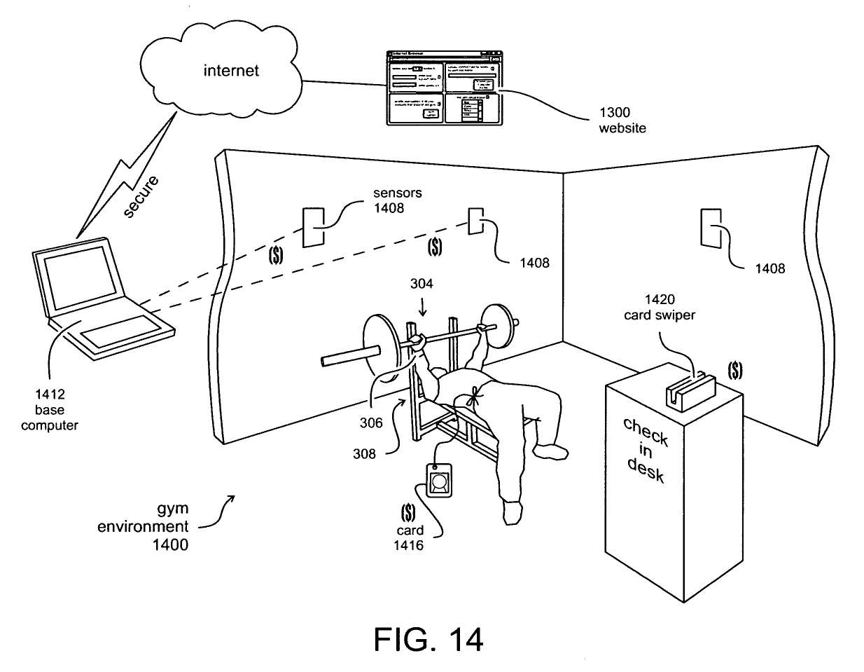

As will be discussed in more detail at least in connection with FIGS. 13 and 14, there will also be a subscription-based web site available to the user of the system 100 of the present invention. There will be at least 3 levels of subscription available to these users. The first, least sophisticated level will cost the least. The next two levels will provide additional features and accessibility.

By combining the microprocessor device 106 with the load cell gloves 104, a user will be able to capture, review and evaluate additional values such as force, rate of force development, power, maximum power, maximum force, as well as other useful data.

The various communication links between any of the cellphone 116, microprocessor device 106, glove 104, sensor 108, and base computer 112 will now be described. A variety of transmission formats can be used, such as but not limited to BlueTooth®, as well as IEEE 802.11 a/b/g/n protocols. However, the system 100 is not limited solely to this configuration, but is flexible and adaptable to suit a variety of environments and equipment. It is desired to avoid having the user purchase specific telephone equipment in order to use the system 100. For example, a wide variety of cellphones 116 can be incorporated within the system 100. However, some cellphones have storage limitations. To accommodate this, the system 100 can be configured to transmit only a bare-bones-minimum amount of data, and warn a user when further data input is not possible.

The protocol for transporting data from the microprocessor 106 to a logging device such as either a base computer 112 or a cellphone 116 will now be described. The data can be transmitted in the form of a serialized packet, and can adapt to any available protocol that understands serialization. This protocol could be, as stated, Bluetooth, but could also be one of the various IEEE 801.11a/b/g/n wireless (Wi Fi) protocols. Many cell phones can accept a variety of streaming serialized protocols including but not limited to the above, but the main benefits behind using Bluetooth in this instance are that the transceiver 102 within the microprocessor device 106 or other sensing device has a conveniently small footprint. Because the transceiver 102 must be unobtrusive and not interfere with the exercise, workplace, or physical therapy routine, yet fit within an area potentially within the microprocessor 106, it is necessary that it be very small and compact.

Bluetooth is also suitable for the system 100 of the present invention because it has a very low power consumption (2.5 mW). Additionally, Bluetooth forms an instant handshake between the microprocessor 106 and the cellphone 116, thereby making it instantly recognized by the cellphone 116 if that cellphone's Bluetooth is enabled. In using a Class 2 radio based on Bluetooth version 2.0 with the Enhanced Data Rate feature enabled, the system 100 can have a distance of as much as 30 feet, yet still deliver as much as 3.0 Mbps data transfer.

Bluetooth is useful with the system 100 of the present invention because it allows for devices to offer services to each other based on an established specification or profile. The secondary device can be made aware of the first device by means of “pairing” the two devices together through either aural or textual handshake. Within the present invention, one exemplary method may use an aural indication that the pairing has succeeded.

Bluetooth also works with many different specifications or profiles. The most practical profile for the transfer of serialized data is the Serial Port Profile. This profile defines the requirements for two peer devices to emulate a serial port for data transfer. The data is transferred at a sustainable rate of 128 kbps, which provides for adequate data transfer for a real time transmission from the sender to the receiver.

Other forms of IEEE 802.11a/b/g/n, allows for a greater data throughput. For example, IEEE 802.11a/b/g (802.11x) is a widespread protocol group for transmitting data via radio to and from either peer to peer or ad hoc networks of computers. 802.11x allows a much higher data transfer rate than Bluetooth, but requires five times the power to implement than Bluetooth.

The various 802.11a/b/g/n protocols also require that the sender be authenticated with the wireless access point, as follows:
the access point sends a beacon frame to make the sender aware of its presence;
the sender sends a probe request to find the access point with a specific SSID;
the sender and access point send management frames back and forth to create the association;
the sender sends the access point an association frame; and
the access point sends the sender an association frame.

At this point the sender is ready send data to the access point over whichever wireless network is employed by the system 100 of the present invention. It is important to note that the system 100 will accommodate the ever-evolving trends in cellphone adaptability. As stated, it is desired that the system 100 incorporate the cellphone 116 already belonging to a user, instead of requiring that user to purchase a cellphone that is compatible with the system 100. To accommodate this, HTC is another cellphone protocol that may be used within the system 100 of the present invention.

Some cellphones have minimal storage space, so it is imperative that the data logging feature of the system 100 not rely upon storage of raw values, but instead the analyzed data that is computed after a workout, occupational analysis, or physical therapy routine is completed. Further, if these values are stored in an optimized format, more data for a workout can be retained, including even possibly some historical data

The system 100 can have varying sampling rates. One possible sampling rate is 30 timestamps/sec, although this suggestion is but for exemplary purposes, so that the present invention should not be considered as limited exclusively thereto.

The system 100 will convey, record, format, and manage both force and distance data from a particular workout or sequence of movements. One way the system 100 will ensure the accuracy of this data is through use of an accelerometer within the glove 104 or other movement-sensing device.

The present invention will also have advanced data-analyzing capability that can determine what exercise a person is doing, and can distinguish between bench-press, arm-curl, dumbbell fly, which looks very different from a cable-fly. In some instances, this feature could save the user from having to enter the specific exercise they are doing.

The system 100 will as stated filter usable data from junk or aberrant data. For example, if the system 100 is measuring a user doing bench-presses, and that user takes a quick break to wipe sweat off or some other non bench-press movement, the system 100 will sense that this movement is not related to any known pattern of exercise, and will strip it out or eliminate it entirely.

The system 100 can also keep track of time of breaks between reps. This could be useful for a user who is desiring to achieve a certain type of tone or bulk, but is taking too long between lifts, allowing lactic acid to build up in the muscles. Some type of prompt within the microprocessor device 106 could alert the user that they need to get back to lifting, or risk losing some of the effect they are working for.

Although FIG. 3 shows a glove 104, microprocessor device 106, and sensor 108 attached to a shoulder, a motion detecting device could be attached to other appendages or extremities as well. This depends on which area of the body it is desired to obtain exercise, therapy, or motion detection. For example, a card dealer in a casino may get the best results with a motion device attached to a wrist. The same may hold true for a baseball pitcher rehabilitating from an injury. Also, all forms of the motion detecting device must include an accelerometer. These can be implemented through a variety of means. Consequently, the glove 104 shown in FIG. 3 is but for exemplary purposes only, so that the present invention should not be considered as limited exclusively thereto.

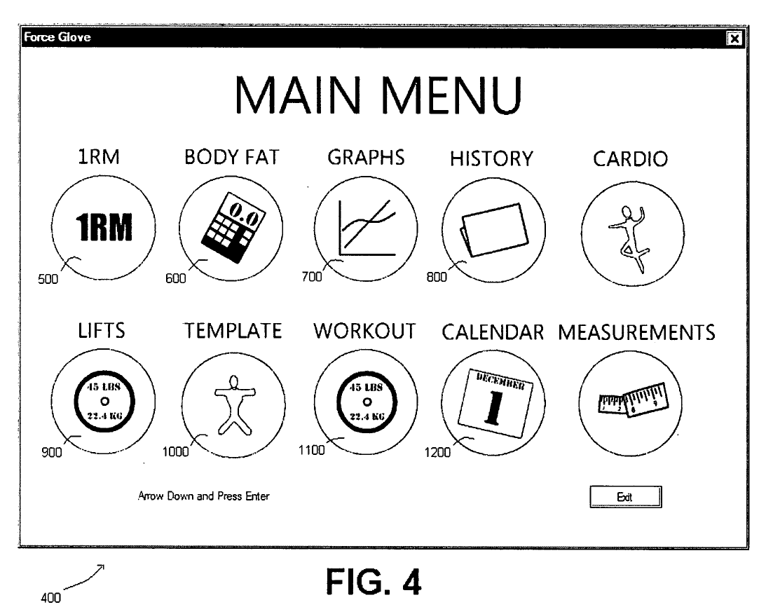

As suggested above, the base computer 112 shown in FIG. 3, or other computing device incorporated within the system 100, can provide significant data-formatting and data-interpretation assistance to a user of the system 100. To explain this, FIGS. 4-12 shows various user panel of a potential software program 400 that could run on the base computer 112. Although FIGS. 4-12 show specific menu layouts and sequencing of buttons and menus, these are but for exemplary purposes only, so that the present invention should not be considered as limited exclusively thereto. Also, although the base computer 112 is suggested to be a typical PC, other types of devices are contemplated within the spirit and scope of the present invention, such as a handheld, PALM™, or Pocket PC device, a laptop, and potentially other portable or stationary computing environments that can be taken into a exercise, workout, manufacturing, medical, or physical therapy area.

Further, the base computer 112 and indeed the entire invention may be portable to a variety of operating systems. Additionally, the user-panels of FIGS. 4-12 can be loaded onto a stand-alone PC, or a PC connected to the Internet, but can also be accessible entirely through a web browser so that a user may view them from any web-connected PC at any location. Such a feature is useful for a person who travels a lot, but works out on the road and wishes to track their work-outs.

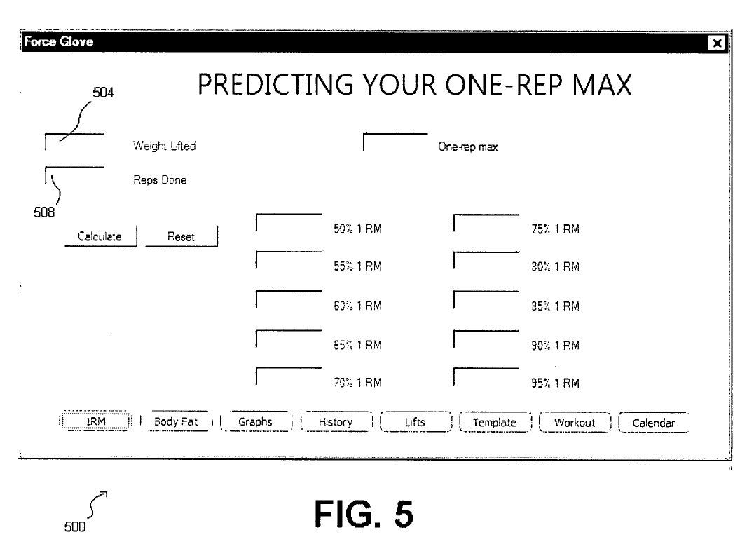

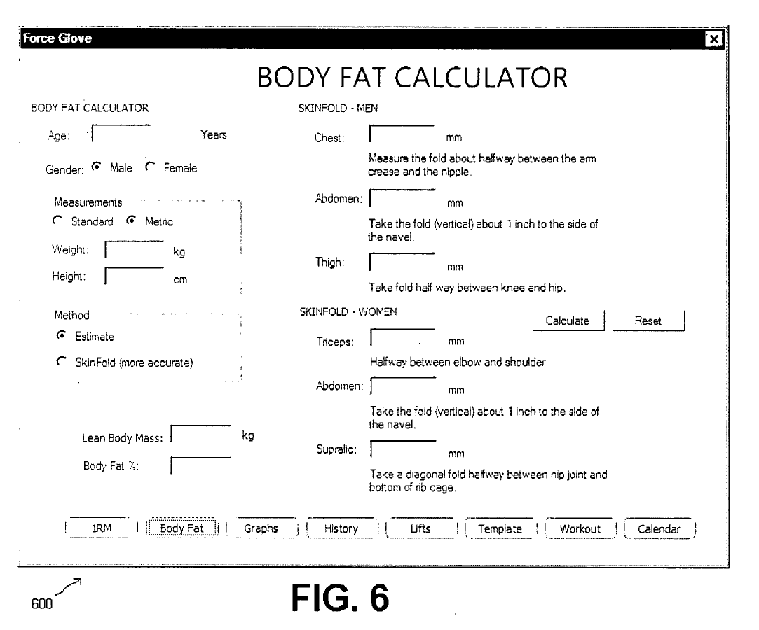

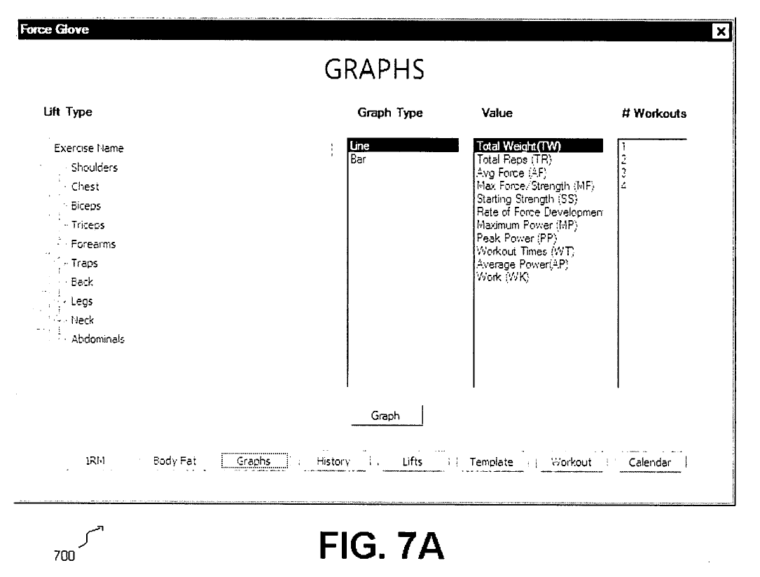

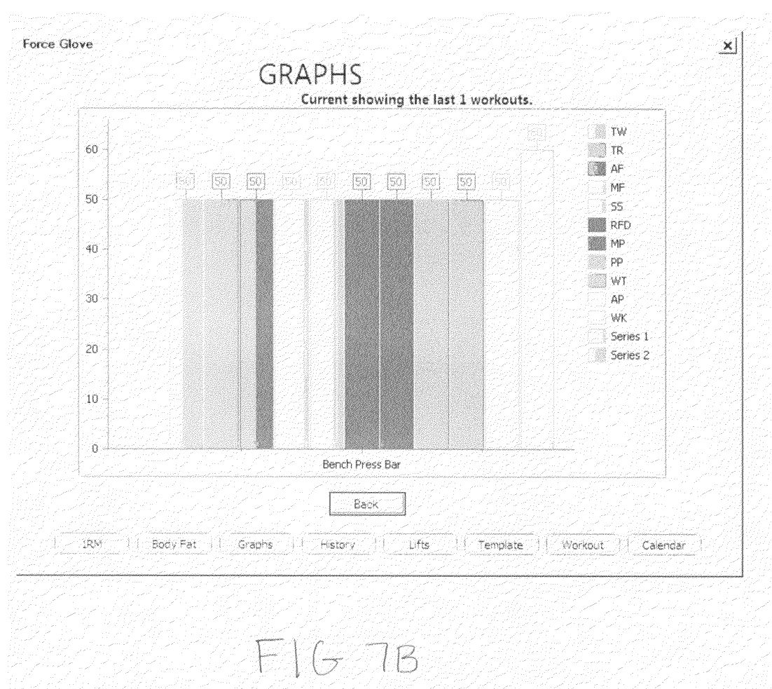

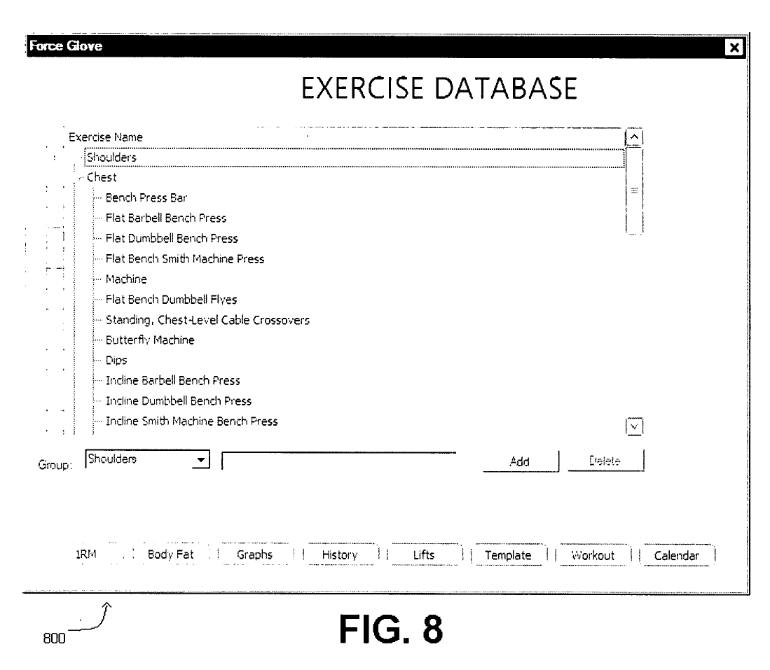

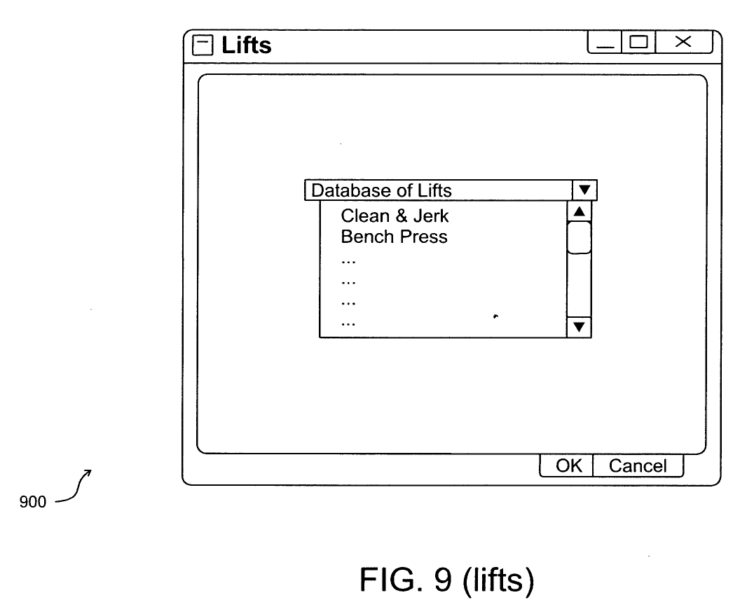

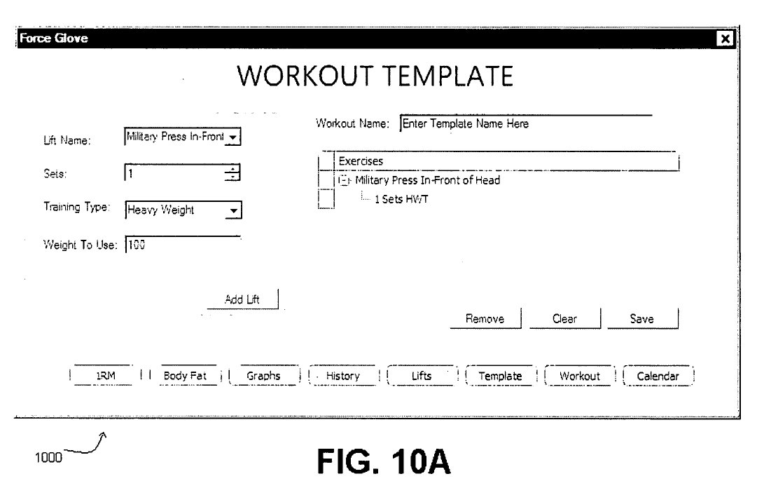

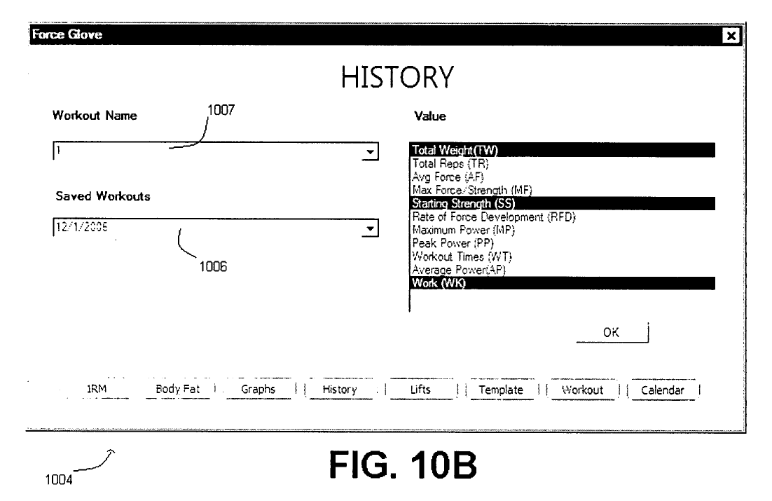

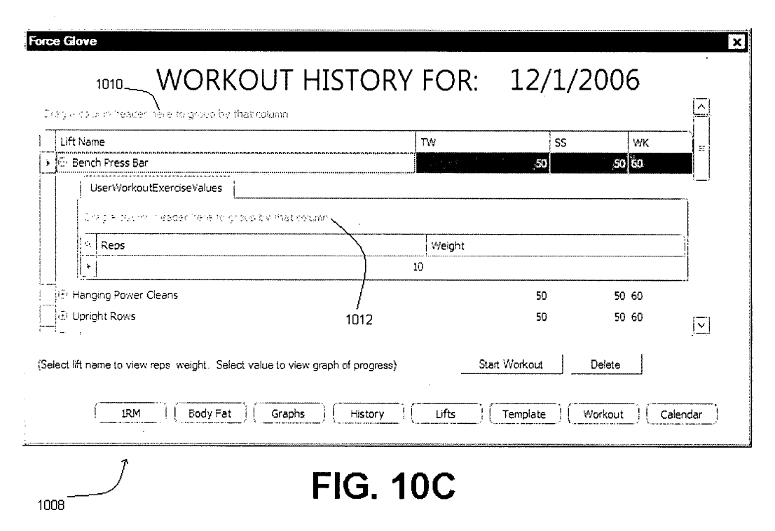

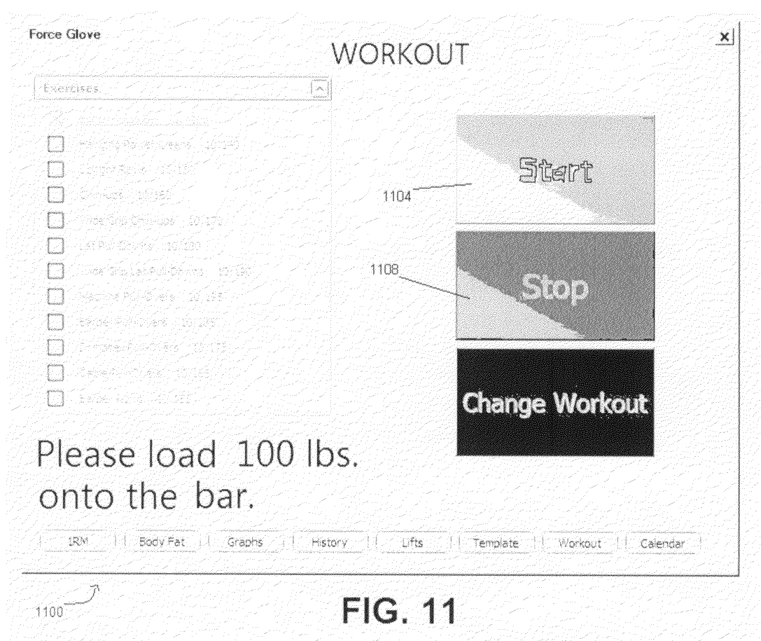

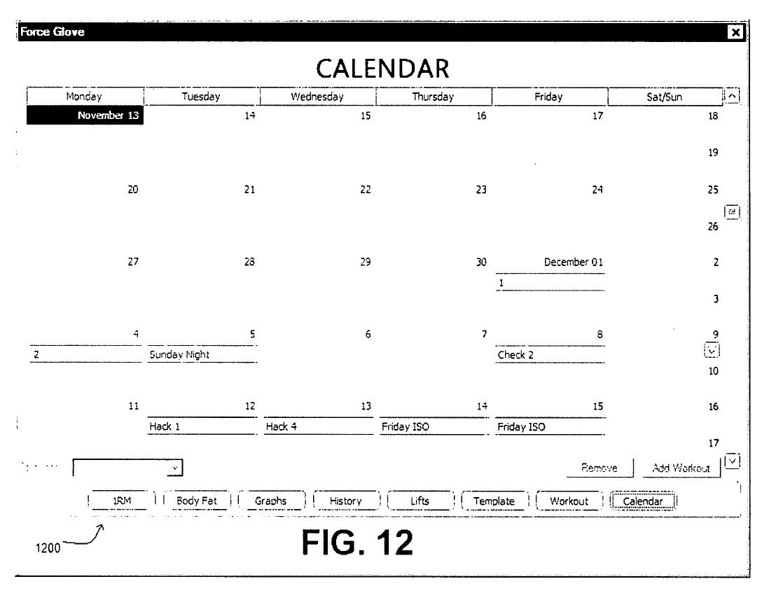

Within FIG. 4 it is apparent that there are 8 main user options within the software 400, some of which branch into several sub-options. These are briefly described as One Rep Max (1RM) 500 (FIG. 5), body fat 600 (FIG. 6), graphs 700 (FIG. 7), history 800 (FIG. 8), lifts 900 (FIG. 9), template 1000 (FIG. 10), workout 1100 (FIG. 11), calendar 1200 (FIG. 12), as well as cardio and body measurements sections. The body measurements are manually entered by a user along with a date. Progress can then be viewed and graphed. The remaining components are described in more detail as follows.

FIG. 5 shows a user panel 500 for obtaining a one-rep maximum (1RM). The data in the “Weight Lifted” 504 and “Reps Done” 508 boxes can either be filled in by the user, or can be assimilated by the system 100 without any user intervention. The bottom of FIG. 5, as well as FIGS. 6-12, show a listing of available options that are scaled versions of the larger icons shown in FIG. 4.

FIG. 6 shows a body fat calculator 600. Some of the data necessary to make this calculation may require measurements that are not facilitated by the system 100.

Clicking on the “Graphs” button can for example show a visual output of the numeric data measured by the system 100, as exemplified by the user panel 700 shown in FIG. 7A, and then supplemented with a user panel 704 containing visual non-numeric detail in FIG. 7B.

FIGS. 8 and 9 show history and lift user panels 800, 900 respectively. The lifts consist of a data base of different styles of exercises. These lists can be updated by the user, to include additional exercises.

Clicking on the “Template” button can for example take the user to the user panel 1000 shown in FIG. 10A, in which a user can build their own workout panels and user menus. To illustrate this, the user panel 1004 in FIG. 10B shows a variety of workout components as well as a listing of previous workouts 1006, as well as the opportunity to save a new workout in the entry box 1007. Next, FIG. 10C shows a user panel 1008 which has a tab 1010 labeled “Drag a column header here to group by that column”. Similarly, a second tab 1012 also contains a “Drag a column header here to group by that column” menu. Such features enable a user to move column headers and thus visually build specific workouts.

Another example of user-configurability of the system 100 of the present invention is that the user can use the template functions of FIGS. 10A-10C to create and save templates of various workouts. One way to achieve this, but not the only way, is by storing the exercise, sets, reps and time between sets and exercises. This stored data can then be used to create the template.

FIG. 11 can fit within various software implementations of the present invention, but is especially useful when the base computer 112 is located near to the individual doing the exercise, workout, manufacturing/workplace movement, or physical therapy. Because of this nearness, the user can hit the “Start” 1104 button when their physical movements begin, and hit the “Stop” 1108 button when they stop.

Finally, FIG. 12 shows a calendar panel 1200 which enables a user to archive and view their workouts from specific days.

As stated, the system 100 of the present invention can incorporate not only cellphones 116 (FIG. 3) but also handheld devices, Palm devices, Pocket PC devices, and can transmit data in realtime, or can store that data and transmit in batch mode. Also, the connections between the various devices shown in FIG. 3 can be either in wired or wireless mode.

A software-only or web-only embodiment in which no sensory devices are worn or used is also contemplated within the spirit and scope of the present invention. Within this environment, a user would input their own data manually, and would make use of the various history, templates, and calendaring aspects of the software 400.

A larger global gym embodiment of the present invention also exists, in which personal data can be stored on a swipe-card that is easy to operate and can be carried with a user even when sweaty. As shown in FIG. 14, the gym environment 1400 could have detectors or sensors 1408 in the wall or ceiling capable of interfacing within the present invention. Such an embodiment manages the various chunks of workout data, customizes, and potentially can send and interface to a user's personal area within a larger portal or website.

The bench-press user of FIGS. 1A and 1B is shown again within FIG. 14, although the gym environment 1400 shown therein is meant to be applicable to any variety and style of gym, and numerous different types of exercise equipment, and not just a bench press. That user is shown wearing a glove 104 and sensor 108 on the shoulder, although again these both could be located elsewhere. FIG. 14 also shows a card 1416 and a card-swipe mechanism 1420 at a check-in desk of the gym environment 1400. The card 1416 and swipe 1420 could be used for allowing a user to have all workout data formatted, logged, and tracked by a base computer 1412, which could then upload the pertinent portions to the website 1300 (FIG. 13), where they are accessible by the user from anywhere.

A website 1300 is shown in FIG. 13, which can work in conjunction with the system 100. This website 1300 can also work with the gym environment 1400 shown in FIG. 14, although the present invention should not be considered as limited exclusively thereto. As shown in FIG. 13, the website 1300 can have various portal characteristics. The ‘$’ signs in FIG. 13 convey that the website 1300 and services can have varying subscription rates depending on utilization and specific features. This optionality enables a user to select a program within the system 100 that suits them financially.

From FIG. 13 it is apparent that the website 1300 may have storage space 1304, 1308 for a user's individual workout data. This way, a user who travels a lot could always have access to their workout data, even when they do not have their computing equipment with them. The element 1308 is especially suited for use with a gym environment 1400, in that by swiping a card, all data can be auto-uploaded (potentially for a $ fee). This saves a user from having to bring his own recording device, such as but not limited to the cellphone 116 (FIG. 3)

As further suggested by the various other ‘$’ signs, the website 1300 could have a tiered payment structure depending on which features of the website are chosen by a user, including but not limited to access to personal trainers (1312, 1316) and other health advisors.

The layouts and proposed implementations of menus in FIG. 13 are but for exemplary purposes only. Other types and styles of user interfaces are also contemplated within the spirit and scope of the present invention, so that the present invention should not be considered as limited exclusively thereto.

If a user wants to know how their workout compares to various other workouts they have done, the software 400 contains a profile feature to find out how that workout rank among all workouts. The profile feature also helps determine strengths and weaknesses. The software 400 also allows a user to view their workout data in the way it is recorded by the data capture device, either the microprocessor device 106, glove 104, or some other mechanism.

The software 400 permits use of a zoom feature, and also allows a user to drill down and view raw numbers. Additionally, it allows a user to highlight data areas of interest and save to view and review. The software 400 also permits selection of various languages, including but not limited to German, French, Italian, Spanish or English, as well as others.

The subscription-based service shown at least in FIG. 13 provides for easy to follow advice and workouts by an in-house personal trainer familiar with the user's goals. The workout planner is where a personal trainer can quickly build schedules. The trainer can copy, edit and move workouts by day or week, for 1 or 100 clients at a time, even weeks at a time.

The self-coached subscription mechanism is for intermediate and advanced athletes looking to add structure to their training by monitoring, analyzing and planning their workouts with an interactive training log which is accessible from the Internet as well as from within a particular gym environment. A training plan wizard which works within a typical browser can customize an entire workout based on personal information of a user.

For example, using the software 400, the trainer can communicate with clients easily either using the Internet or on-site. The trainer will have access to quick views that shows their a last workout, as well as email notifications, private messaging and other features to facilitate tracking and managing of various clients. The software 400 can show how a client performed each day, their comments and feedback, and track their totals for the workout and week, all within a single page.

The software 400 also allows for tracking of planned vs. actual performance. A user can plan their workouts, and can move, copy and edit workouts by the day or by week. The graphing tools lets users see needed data, including overall planned vs. actual workout. Further drill-down to exercise, repetitions, sets, and comparisons to previous workouts is also available. Using the software 400 within the system 100 of the present invention, a client can be managed by a coach, nutritionist, therapist and other contributors all at the same time. This enables a true team approach to managing the health and training schedule of an athlete.

As suggested earlier, the system 100 of the present invention is suitable for applications within a variety of fields, including but not limited to kinesiology, ergonomics, accident prevention, improved workplace motion, and physical rehabilitation. Kinesiology studies can make use of the system 100 by, for example, alerting a user to the fact that in an occupation workplace environment they are lifting, or moving in a way that is not to their benefit. This is especially important because people get used to moving a certain way, and have difficulty adjusting, and tend to blame their back pain on unrelated reasons, when in fact they can be contributing to it themselves by their own movements.

Ergonomic studies can make use of the system 100, by, for example, alerting a user to the fact that s/he is slouching in a chair, putting undue strain on the lumbar region, or in some other way doing something now that may cause them to wake up at 4:15 AM with unpleasant pain. Often, their posture can be corrected with minimal adjustment by a user, resulting in significant ergonomic benefit, so that the next occurrence of 4:15 AM can pass by without incident. A motion detector attached to the wrist could assist in preventing users from extending their arms the wrong way, thereby heading off a possible problem with carpal-tunnel syndrome.

Accident prevention can occur when a worker is involved in physical activity, but is cutting corners or taking risks because they are tired, or experiencing an energy deficit. One possible example of this is a shipping company worker reading an address on a package while it moves along on a conveyor belt. The user must read, make a decision, then pull that package from the belt, rush to locate that package inside the delivery truck, and returning to the belt before any other packages have passed by. Because many different physical and mental activities are required in this process, and also because the user's eyes are diverted, and this process involves going up and down steps of a truck, this work environment is ripe with physical accidents such as slips, falls, and head-whams. The system 100 can be useful in measuring a worker's movements, assisting in reducing wasted motion, thereby reducing wasted energy, thereby increasing general overall alertness. It can also assist in detecting when a user is slowing down to the point where they are missing packages on the belt, or are otherwise costing the employer money and time.

Another example of how the system 100 can assist with improved workplace motion is a card dealer in a casino. It is well known that card dealers within a casino only work for ½ hour at a stretch, and then are required by law to be relieved. The dealers then take a short break allowing them to re-charge their alertness, before they return to the casino floor to relieve someone else.

This situation exists because when a dealer is working, it is very important that the dealer be alert and awake in order to properly monitor the game, prevent cheating, but also to keep play moving and keep the betting and cash-flow freely occurring without impediment. Accordingly, the system 100 can tell when a dealer's arm motions indicate a level of tiredness that is likely to be coincide with reduced mental alertness. Similarly, if a dealer is physically tired, it is more possible that they will accidentally turn over a card, thereby requiring the entire hand and all bets be closed down, and the hand re-dealt. This is bad for the casinos because any such re-deals or errors result in the casino making less money.

To address this, the base computer 112 within the system 100 could be equipped with algorithms and movement patterns for specific dealers, with tolerances and ranges to allow for normal human deviation. If a dealer falls below or strays outside the tolerances, and pit boss can be alerted to see if the dealer is too tired to go on dealing, and needs a break.

The system 100 present invention can be useful anywhere repetitive motions occur, including with an unknown weight. This can include, as stated, casino card dealers, or auto workers, or other types of manufacturing environments. More importantly, in a workman's compensation dispute, the system 100 of the present invention could be useful either on the plaintiff side, or alternatively the defendant's side. This is because the system 100 makes objective, independent observations and measurements about a person's movement, where those observations and measurements are accurate and reliable. Various software algorithms and other intelligence exist within the system 100 to filter out and strip out aberrant data. The result is data that is reliable, accurate, cannot be fudged or altered, and could then potentially be admissible in a legal dispute or litigation.

The system 100 also contemplates the use of webcams and data-forwarding, so that doctors may remotely monitor aged invalids needing physical therapy in order to have any chance of improving their health. This way, a patient in poor health, and also with limited range of motion, could still have a supervised workout or physical therapy type of experience with greatly reduced risks, and at a fraction of the expense of a home visit. It is well-known that shut-ins need physical therapy also.

Even supposing no video monitoring occurs, some of the more self-motivated shut-ins can do their various workouts with less supervision without fear of collapsing, undue strain, or injury. The system 100 can apprise a qualified practitioner supervising a patient's workout as to exactly when a patient's vital signs such as pulse or heart rate are reaching a dangerous threshold. The pulse of a user of the system 100 can be obtained through galvanic skin response (the hairs change direction). Such a response can be detected by the glove 104, among other means. The user can then have the data from that workout relayed directly to the doctor's office.

Cardiac monitors can also be employed within the system 100 of the present invention. If a patient misses a workout due to extreme pain or the sensation they are about to blow a blood vessel, the data can help verify their strain. The doctor/therapist won't then think the patient is merely being lazy or hypochondriac.

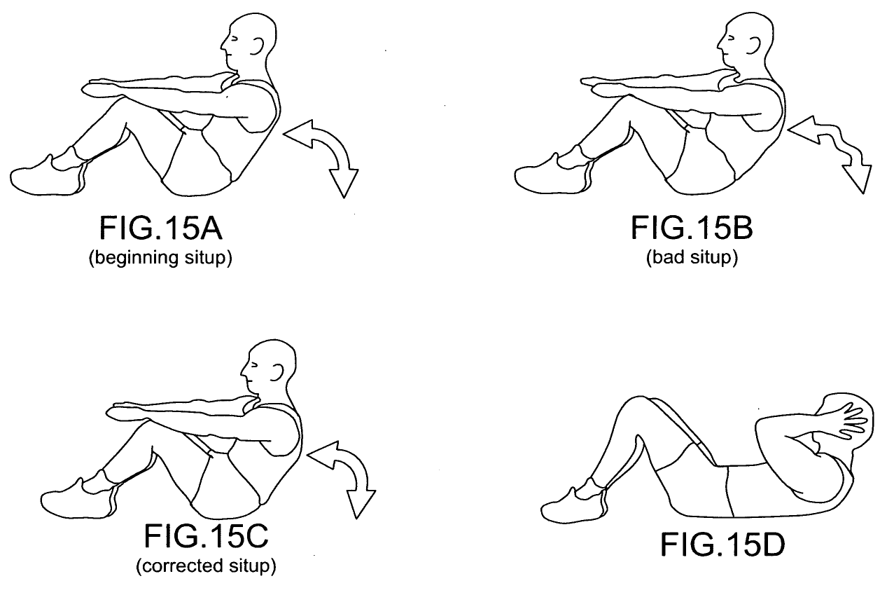

FIGS. 15A-D show an example of how the system 100 can be used in physical therapy. Many elderly patients, particularly women who have had multiple children, develop a paucity of strength and reduced elasticity of the abdominal muscles as they age. One way to address this is by doing a specific form of exercise targeted at this weakness, known as modified sit-ups. However, it is difficult to indoctrinate elderly women into making this part of an exercise routine. They tend to resist, and make every excuse on earth for not doing them. Also, if the patient goes about it the wrong way, they can really mess up their back.

FIG. 15A shows the motion of an elderly woman doing a sit-up in a desired format. However, FIG. 15B shows how an elderly woman who has not done sit-ups before may strain herself, particularly an elderly woman with significant extra body mass and also atrophy of the musculature from many years of disuse. Doing sit-ups as shown in FIG. 15B can cause the elderly patient to give up on exercise altogether, throw out their back, or pee on themselves due to unexpected strain on the bladder.

To address this, FIG. 15C shows how the system 100 anticipates and corrects the sit-up motion of an elderly user. From FIG. 15C it is apparent that the user is employing a more correct motion in doing the sit-up. Because of this, less patient discomfort, and less accidental peeing, results.

When done properly, sit-ups help tone the muscles in your midsection, which can help protect your back as well as improve your physique. When done improperly, however, sit-ups can be a waste of effort and possibly even harmful. The most beneficial sit-up has the user holding their hands at their sides, or across their chest (as shown in FIG. 15D).

The main purpose of sit-ups is to strengthen the stomach muscles by challenging the abdominal group: the rectus abdominus muscles, or “abs” (two thin strips of muscle that extend from the breastbone to the pelvis), and the three layers of muscles that flank the abs. Great care and excellent technique are required to strengthen the abdominal muscles with sit-ups. To be effective, sit-ups must pull the torso upward from a lying position toward the knees using only the abdominal group, as shown in FIGS. 15C and 15D. It is important to not interlace the hands behind the neck.

Often, however, other, more powerful, muscles (those that flex the legs and hips) do much of the work. This is especially true with straight-leg sit-ups. To address this, bending the knees during sit-ups helps neutralize the action of the hip flexors and makes the abdominal muscles work more. Even so, the abdominal group tends to be involved only in the initial phase of the sit-up, after which the hip flexors take over. In addition, doing sit-ups rapidly and with momentum, knees bent or not, does not work the abdominal group very much. That's why raising slowly only part way works the abdominal muscles best.

Sit-ups also can be hazardous to your lower back, especially when using the straight-leg variety, which arches the back and may create overextension and strain. Twisting (right elbow to left knee and vice versa) at the top of the sit-up movement, as shown in FIG. 15B, is not only useless, it places tremendous rotational stress on the lower back that can lead to injury. The system 100 of the present invention seeks to address these issues.

To detect the various motions within FIGS. 15A-D, the elderly patient could wear for example two shoulder bands with motion detectors, as well as a 3^{rd} motion detector and/or sensor around her waist. This way, information about how she is unproductively twisting and torque-ing her back could be obtained. However, these implementations are but suggestions, and for exemplary purposes only. The important consideration is that the system 100 can be adapted to give useful cogent germane information across a wide variety of physical therapy requirements.

It is well-known that the long-term goal of physical therapy is to teach a patient how to manage and/or alleviate current symptoms, and how to prevent future episodes of pain from recurring. Other functional goals are made based on the patient's specific complaints, whether they be an inability to sleep through the night without pain, stand/walk for daily activities or exercise, sit for an extended period of time, or turn the head adequately for driving. Specific goals to increase the strength or flexibility of specific sources of pain are then made to facilitate the functional goals.

The load cell technology can be used as a tool to evaluate the effectiveness of these various physical therapy programs. Strength and flexibility can be monitored as exercises are performed and the information can provide feedback to the patient and therapist. With this timely information adjustments to the program can be made as changes are detected in performance.

A web based service will be available for use with the various physical therapy features of the present invention. This will allow the patient to transmit exercise data to the therapist. The therapist can use this tool to monitor performance and make recommendations as needed. This application will save both time and expense for the patient and therapist.

There is another reason that record keeping of a physical workout could be useful. Some home-schooled children are subject to local, state, and potentially even national physical education requirements.

The system 100 can beep if it detects a problem, and in some embodiments will avoid requiring a user to look at a certain device, although there may be instances where viewing a monitor may be convenient. However, more complex visual indicators can be rented, in conjunction with a specific health club or gym payment arrangement discussed earlier and shown in FIG. 14.

With the technological advancements and reduced expenses in today's home computing, the system 100 of the present invention enables various types of complex medical testing can be performed in the home and then logged into a doctor's office. This would have the effect of reducing the amount of travel time and home visits by a skilled practitioner, thereby reducing medical expenses, increasing the quality of medical care, and enabling a more proactive medical system that can detect problems before they occur, rather than after.

The computer software 400 running within the system 100 can even detect a certain type of swimming stroke, arm motion such as that used by a baseball pitcher, or other distinctive and highly repeatable motion. Because algorithms can be set up to identify certain repetitive motions, the software 400 can under specific circumstances determine and begin logging workout data even when un-prompted by the user.

The system 100 can also detect when a user is engaged in certain type of lifting. By pairing an arm monitor with a lower back monitor, the system 100 can detect when a user is lifting improperly, thereby causing strain on their back. Such a user can be apprised that they may be causing some of their own problems, and instructed on how to lift in a way that, although initially may feel un-natural, may reduce the risk of back pain or even back injury. Certainly such corrective action can reduce the risk of various types of repetitive motion injuries.

Training programs for office and industrial workers teach employees how to use their bodies in the most efficient and least detrimental ways. This training provides workers with the knowledge to change their working habits and possibly their work environment to reduce stress on their bodies.

The load cell technologies of the present invention could be used to provide a means of determining whether the principles leaned in the training programs are applied and effective. These technologies provides a tool for monitoring employee on the job activity to identify ergonomic risks and provide suggested modifications including but not limited to repositioning their tools, furniture, equipment, stretching, work pace, posture and lifting techniques.

Variables relating to movement, weight, distance and posture can be monitored using load cell technologies of the present invention. These variables are evaluated and provide the necessary data to determine if the employee is performing efficiently and in the least detrimental way. Additional training can then be provided to improve work habits as necessary.

One cause of workplace injuries is manual materials handling. Workers lifting and carrying equipment or materials can be injured when they use improper techniques, twist repeatedly, stand in awkward positions, or try to handle heavy loads without assistance. To reduce back injuries on the job, preventive programs are necessary, covering factors such as proper lifting techniques, workplace posture, ergonomics, and warm-up exercises before work.

The load cell technology can be used to monitor movement to identify improper lifting techniques. For example, the witch of the stand, load weight, position of the load and back position can all be monitoring while and employee is working. The results can then be used to individuals at risk of injury due to improper lifting techniques. Using the present invention, these individuals can then be provided additional training to reduce or eliminate the risk of injury due to improper lifting techniques.

The present invention can also monitor children's activity, although the child's cooperation in keeping the motion-sensing device such as but not limited to the glove 104 intact may be helpful.

Parents could also use the system 100 to monitor the care of their children while in day care centers. Additionally, as stated, government agencies responsible for ensuring that home-schooled children get a certain amount of PE can monitor a child's activity. The data storage capabilities of the system 100 may be useful in such a case, because they are tamper-proof and fudge-proof, and as stated are intended to be admissible in legal proceedings.

The present invention can be used in fitness centers, hospitals, schools. The capture device & PC software could be sold by retail, Internet, or catalog sales. The subscription services could be either on an individual basis, or on a group basis as part of a product offering of fitness centers, schools, or other entities.

The various aspects of the present invention have been described in detail with particular reference to preferred embodiments thereof, but it will be understood that variations and modifications can be effected within the spirit and scope of the invention as described herein. It is anticipated that various changes may be made in the arrangement and operation of the system of the present invention without departing from the spirit and scope of the invention, as depicted in the following claims.

What is claimed is:

1. A system for monitoring an exercise workout, comprising:
a plurality of motion-sensing devices strategically configured to be positioned upon an individual participating in the workout;
a data collection device, configured to be positioned near the individual and in wireless communication with the motion-sensing devices; and
a base computing device, in communication with both motion-sensing and data-collection devices, for coordinating, managing, and formatting collected data related to the workout.

2. The system of claim 1, further comprising:
the data collection device is a cellphone.

3. The system of claim 1, wherein:
the plurality of motion-sensing devices each contain an accelerometer.

4. The system of claim 1, further comprising:
the plurality of motion sensing devices have one or more sensors embedded therein including a sensor which attaches to an area used for determining distance of movement of the individual, and one or more transmitters for forwarding data.

5. The system of claim 1, further comprising:
sensors and transmitters configured to relay data to each other and also to the base computing device.

6. The system of claim 2, further comprising:
wireless communication links between the cellphone, motion sensing devices, and base computing device.

7. The system of claim 1, further comprising:
the plurality of motion-sensing devices contain one or more load cell sensors, a heart rate monitor, and a distance calculating device located in a mechanism suitable for attachment to a human body.

8. The system of claim 1, wherein the base computing device is further configured to provide data-analyzing capability that can determine what exercise a person is doing, by distinguishing between various exercises.

9. The system of claim 1, further comprising:
advanced data-analyzing capability that can filter usable data from junk or aberrant data.

10. The system of claim 1, further comprising:
the data collection device includes a microprocessor device worn by the user comprising a user-operable keypad and a display.

11. The system of claim 10, wherein the microprocessor device further comprises a Universal Serial Bus port and a slot for optionally accepting a memory stick.

12. The system of claim 10, wherein all data input to the microprocessor device occurs manually.

13. The system of claim 10, wherein all data input to the microprocessor device occurs through an automated wireless link with the plurality of motion sensing devices.

14. The system of claim 11, wherein all data input to the microprocessor device occurs through the memory stick.

15. The system of claim 10, wherein:
the microprocessor device has internal storage.

16. The system of claim 12, wherein:
the microprocessor device operates in stand-alone mode comprising a basic workout log where all data input occurs manually.

17. The system of claim 10, wherein the microprocessor device further comprises a prompt for alerting the individual to lapses of time.

18. The system of claim 1, further comprising:
software running on the base computing device, wherein the software further comprises:
a graph feature for displaying historical workout data in graphic form in order to allow visual comparisons;
a history feature providing a record of previous saved workouts; and
a cardio feature for a user to track length, distance, intensity, heart rate, and calories burned.

19. The system of claim 18, further comprising:
a microprocessor device responsive to the software, thereby enabling the user to transfer information from the microprocessor device to the base computing device and back.

20. The system of claim 18, wherein the software further comprises templates which allow the user to build their own workout panels and user menus.

21. The system of claim 18, wherein the software further comprises a workout menu comprising:
a variety of workout components;
a listing of previous workouts; and
a function to save a new workout in the entry box.

22. The system of claim 18, wherein the software further comprises:
a zoom feature allowing a user to drill down to different levels of data.

23. The system of claim 18, wherein the software further comprises:
a feature for tracking of planned vs. actual performance.

24. The system of claim 1, further comprising:
a subscription-based web portal responsive to the data accumulated by any of the a plurality of motion-sensing devices, data collection device, or base computing device.

25. The system of claim 24, wherein the web portal further comprises:
a plurality of fitness services having varying subscription rates depending on utilization and specific features.

26. The system of claim 25, wherein the fitness services further comprise:
access to personal trainers and other health advisors.

27. The system of claim 24, wherein the web portal further comprises:
storage space for a user's individual workout data, so that the user who travels a lot could always have access to their workout data by connecting to the web.

28. The system of claim 1, further comprising:
a gym environment having detectors or sensors in a wall or ceiling capable of interfacing with the plurality of motion-sensing devices, data collection device, and base computing device, wherein the gym environment can manage, customize, and store the collected data.

29. The system of claim 28, further comprising:
a card and a card-swipe mechanism at a check-in desk of the gym environment

30. The system of claim 24, further comprising:
a gym environment having detectors or sensors in a wall or ceiling capable of interfacing with the plurality of motion-sensing devices, data collection device, and base computing device, for managing, customizing, and storing the workout data, and sending and interfacing that data with a user's personal area within the subscription-based web portal.

31. The system of claim 30, further comprising:
a card and a card-swipe mechanism at a check-in desk of the gym environment.

32. A method of monitoring and data-logging an exercise workout, comprising:
tracking movement of a user's appendage;
calculating distance, force, and time of movement data based on that tracking;
transmitting the data to a recording device;
formatting the data to maximize value for the user, according to predetermined criteria set by the user; and
storing the data.

33. A software module for managing workout data, comprising:
a component for calculating a one repetition maximum comprising a screen interface for accepting user input needed for the calculating;
a component for calculating body fat comprising a screen interface for accepting user input needed for the calculating;
a workout history component comprising a screen interface for accepting user input needed for the calculating;
a lifts component comprising a screen interface for accepting user input needed for the calculating;
a plurality of template components for allowing a user to customize their own screen interfaces;
a workout component comprising a screen interface for accepting user input;
a calendar component;
a cardio component; and
a body measurement component comprising a screen interface for accepting user input.

34. A payment system for managing workout data, comprising:
tracking and recording data from a workout of a user;
charging a fee for access to the data;
allowing the user to communicate with a personal trainer, where the trainer has access to the data;
charging a fee for access to the personal trainer;
allowing the user to review past workout data;
charging a fee for access to the review;
enabling auto-upload of all workouts performed in any gym belonging to a predetermined group; and
charging a fee for the auto-upload.

35. A program storage device readable by a machine, tangibly embodying a program of instructions executable by the machine to perform method steps for monitoring a physical activity, said method steps comprising:
tracking movement of a user's appendage;
calculating distance, force, and time of movement data based on that tracking;
transmitting the data to a recording device;
formatting the data to maximize value for the user, according to predetermined criteria set by the user; and
storing the data.
